(19) United States
(12) Patent Application Publication
(10) Pub. No.: US 2004/0252098 A1
(43) Pub. Date: Dec. 16, 2004

(54) Liquid crystal display panel

(76) Inventors: Seok-Lyul Lee, Taoyuan Hsien (TW); Ming-Tien Lin, Lujhou City (TW); Tean-Sen Jen, Taoyuan Hsien (TW)

Correspondence Address: RABIN & Berdo, PC, 1101 14TH STREET, NW, SUITE 500, WASHINGTON, DC, 20005, US

(21) Appl. No.: 10/714,963

(22) Filed: Nov. 18, 2003

(30) Foreign Application Priority Data
Jun. 11, 2003 (TW) 92115795

(51) Int. Cl. G09G 3/36

(52) U.S. Cl. 345/103

(57) ABSTRACT

A liquid crystal display panel. The liquid crystal display panel is driven by a column inversion driving mode and includes a plurality of data lines, a plurality of scan lines, a plurality of display unit pixels and a plurality of display unit blocks. Each set of two adjacent data lines and two adjacent scan lines defines the boundary of one display unit pixel wherein each data line interlaces with both scan lines. Each display unit pixel comprises a control transistor, a storage capacitor, a common electrode, and a pixel electrode. In addition, the display unit pixels within any display unit block between two adjacent data lines are coupled to one of the two adjacent data lines, while the display unit pixels within another adjacent display unit block between the two adjacent data lines are coupled to the other of the two adjacent data lines.

### BACKGROUND OF THE INVENTION

1. Field of the Invention

The present invention relates to a liquid crystal display panel, and particularly to a liquid crystal display panel is driven by column inversion to reduce power dissipation.

2. Description of the Related Art

FIG. 1 shows a schematic diagram of a conventional thin film transistor liquid crystal display (hereinafter referred to as “TFT-LCD”). As shown in FIG. 1, a liquid crystal display (LCD) panel 1 is formed by interlacing data lines (represented by D11, D12, D13, . . . , D1y) and scan lines (represented by G11, G12, G13, . . . , G1x). Each set of two adjacent data lines and two adjacent scan lines defines the boundary of one display unit pixel wherein each data line interlaces with both scan lines. The interlacing data line D11 and scan line G11 correspond to the display unit pixel 100. Like any other display unit pixel, the equivalent circuit of the display unit pixel 100 comprises a thin film transistor (hereinafter referred to as “TFT”) 10, a storage capacitor Cs10, a pixel electrode, and a common electrode. The TFT 10 has a source terminal, a gate terminal coupled to the scan line G11, and a drain terminal coupled to the data line D11. The storage capacitor Cs10 stores a driving voltage. The pixel electrode and the common electrode make up a liquid capacitor C1c10.

A scan driver 3 sequentially outputs scan signals to scan lines G11, G12, G13, . . . , and G1x according to a scan control signal. When receiving a scan signal, a scan line corresponding to a row turns on the TFTs within all display unit pixels corresponding to the row, while the TFTs within all display unit pixels corresponding to all other rows are turned off by other scan lines. When the TFTs within all display unit pixels corresponding to a row are all turned on, the data driver 2 outputs corresponding video signals with gray scale values to y display unit pixels corresponding to the row through the data lines D11, D12, D13 . . . , and D1y according to image data prepared for but not yet displayed. Each time when the scan driver 3 finishes scanning all x rows, the operation to display a single frame is completed. Therefore, the object of displaying images is achieved by repeatedly scanning scan lines and outputting video signals.

Typically, there are two kinds of video signals transmitted by the data lines D11, D12, D13, . . . , and D1y: positive and negative video signals sorted by their relationships with the common electrode voltage VCOM. Continuous bias with single polarity shortens the life of liquid crystal molecules. To avoid this, display unit pixels within odd and even frames are driven alternately with positive and negative video signals, as a typical technique for TFT-LCD.

The different polar video signal in each display unit pixel can be divided into two driving modes: dot inversion mode and Z inversion mode.

FIG. 2 shows a schematic diagram of an LCD panel with dot inversion mode. Video signals S21, S22, S23, . . . , and S2y are respectively carried by data lines D21, D22, D23, . . . , and D2y and are alternately positive and negative within a signal frame. Drain terminals of control transistors within the display unit pixels are coupled to the corresponding data lines (D21, D22, D23, . . . , D2y). For example, a drain terminal of a display unit pixel 200 is coupled to a data line D21. When control transistors within all display unit pixels are turned on according to scan signals carried by scan lines (G21, G22, G23, . . . , D2y), the video signals are output to the corresponding display unit pixels. FIGS. 3a and 3b show the polarity of the video signals received by each display unit pixel in dot inversion driving mode. Here, FIG. 3b shows the polarity of the video signals following that of FIG. 3a. As shown in FIGS. 3a and 3b, the video signal of each display unit pixel is opposite its adjacent display unit pixels on a signal frame. As shown in FIG. 2, a drain terminal of a control transistor 20 within a display unit pixel 200 is coupled to a data line D21; likewise, drain terminals of control transistors within other display unit pixels are coupled to corresponding data lines D22, D23, . . . , and D2y. When scan signals carried by scan lines G21, G22, . . . , and G2x sequentially turn on control transistors within all display unit pixels, video signals S21, S22, . . . , and S2y are input to corresponding display unit pixels. FIGS. 3a and 3b are schematic diagrams showing polarities of the video signals received by each display unit pixel with conventional dot inversion driving mode. Moreover, FIG. 3b shows polarities of video signals within the frame next to that of FIG. 3a. As shown in FIGS. 3a and 3b, video signals received by each display unit pixel have polarities opposite those of video signals received by other adjacent display unit pixels within the same frame.

FIG. 4 shows a schematic diagram of an LCD panel with Z inversion driving mode. Each of the video signals S41, S42, . . . , and S4y carried respectively by data lines D41, D42, . . . , and D4y has a fixed polar level within a frame and another polar level with an opposite polarity within the next frame. As shown in FIG. 4, a drain terminal of a control transistor 40 within a display unit pixel 400 is coupled to a data line D41, and a drain terminal of a control transistor 41 within a display unit pixel 401 is coupled to a data line D42. Drain terminals of control transistors within two adjacent display unit pixels corresponding to one row are respectively coupled to two adjacent data lines. As well as dot inversion driving mode, FIGS. 3a and 3b also show polarities of the video signals received by each display unit pixel with Z inversion driving mode. With Z inversion driving mode, video signals received by each display unit pixel have polarities opposite those of video signals received by other adjacent display unit pixels within the same frame. The polarity dispositions of video signals received by each display unit pixel with dot inversion driving mode and with Z inversion driving mode are the same. Each of the video signals S21, S22, . . . , and S2y with dot inversion driving mode is an alternately positive and negative video signal within a signal frame, while each of the video signals S41, S42, . . . , and S4y with Z inversion driving mode has a fixed polar level within a frame and has another polar level with an opposite polarity within the next frame. Therefore, comparing the two modes, higher frequency is used when alternately switching polarities of video signals with dot inversion driving mode between positive and negative, such that more power is dissipated. Note that polarities of video signals S2y and S4y are not necessarily the same as those of the signals shown in FIGS. 2 and 4, rather they are determined by a value y.

Before release, TFT-LCDs are tested for flicker with the check subpixel pattern wherein the display unit pixels within a single frame are turned on and off alternately. FIGS. 5a and 5b show schematic diagrams of a conventional LCD panel examined with check subpixel, wherein white blocks and oblique blocks respectively represent display unit pixels turned on and off. FIG. 5b shows the schematic diagram of an LCD panel examined with check subpixel within the frame next to that of FIG. 5a. Polarities of video signals received by the display unit pixels turned on are negative within a single frame as shown in FIG. 5a and are positive within the next frame as shown in FIG. 5b. When each of the single frames driven by either dot inversion or z inversion is tested sequentially with check subpixel, polarities of video signals received by display unit pixels turned on within each single frame are sequentially positive or negative. Because positive and negative video signals have different brightness, flicker is conspicuous.

### SUMMARY OF THE INVENTION

An object of the present invention is to provide a liquid crystal display panel driven by column inversion to reduce power dissipation, with reduced flicker when testing with check subpixel.

To achieve this object, the present invention provides a liquid crystal display panel. The liquid crystal display panel comprises a plurality of data lines, a plurality of scan lines, a plurality of display unit pixels, and a plurality of display unit blocks. Each set of two adjacent data lines and two adjacent scan lines defines the boundary of one display unit pixel wherein each data line interlaces with both scan lines. Each display unit pixel comprises a control transistor, a storage capacitor, a common electrode, and a pixel electrode. In addition, the display unit pixels within any display unit block between two adjacent data lines are coupled to one of the two adjacent data lines, while the display unit pixels within another adjacent display unit block between the two adjacent data lines are coupled to the other of the two adjacent data lines.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a schematic diagram of a conventional thin film transistor liquid crystal display.

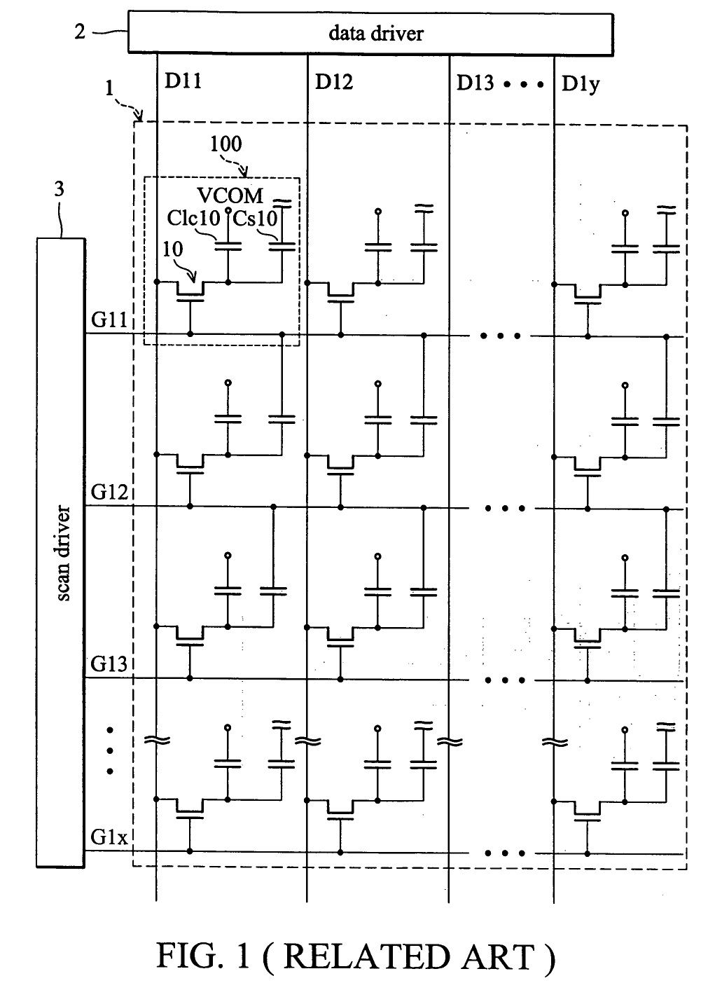

FIG. 2 shows a schematic diagram of a liquid crystal display panel (LCD panel) with dot inversion driving mode.

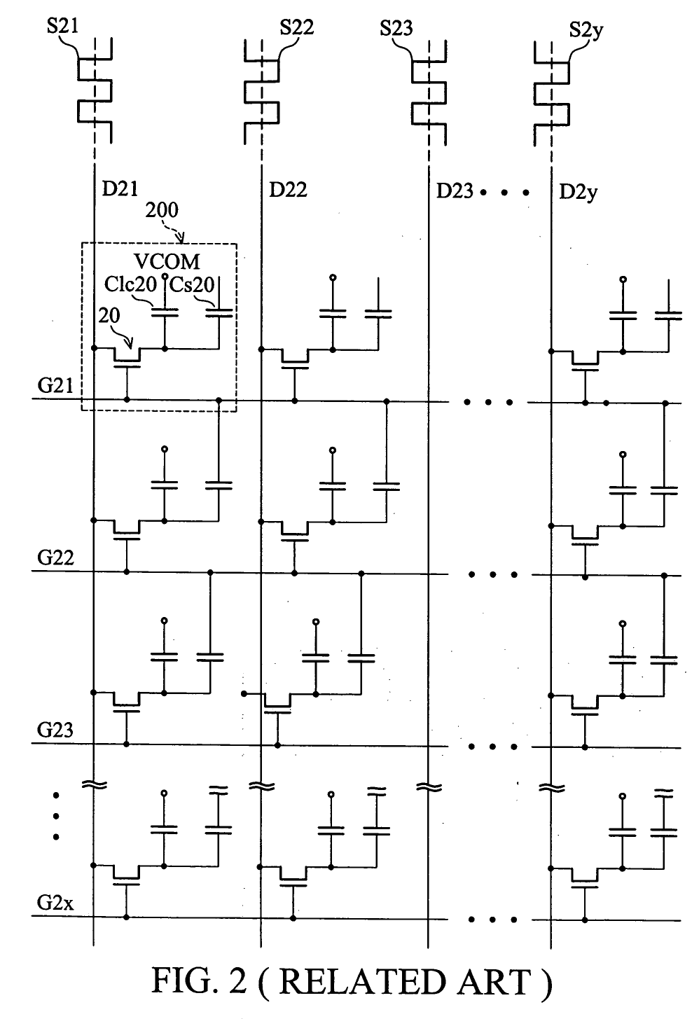

FIGS. 3a and 3b are schematic diagrams showing polarities of the video signals received by each display unit pixel with either conventional dot inversion driving mode or Z inversion driving mode.

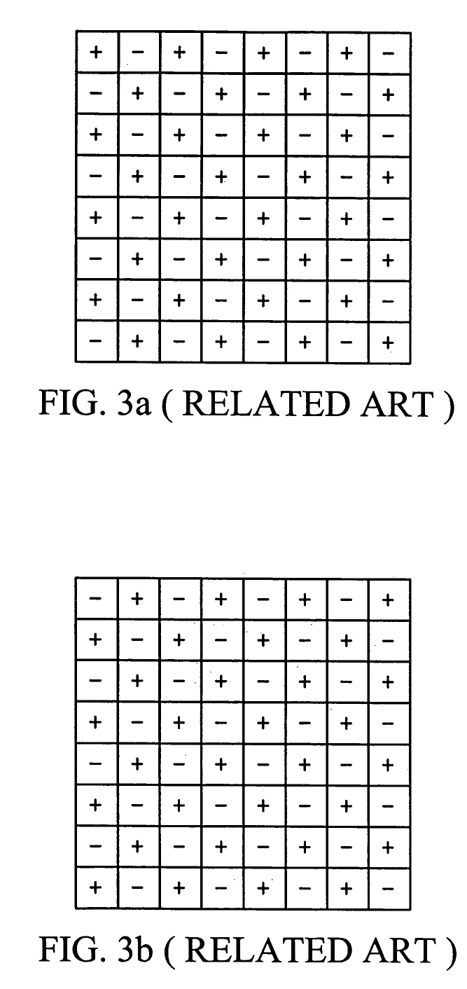

FIG. 4 shows a schematic diagram of an LCD panel with Z inversion driving mode.

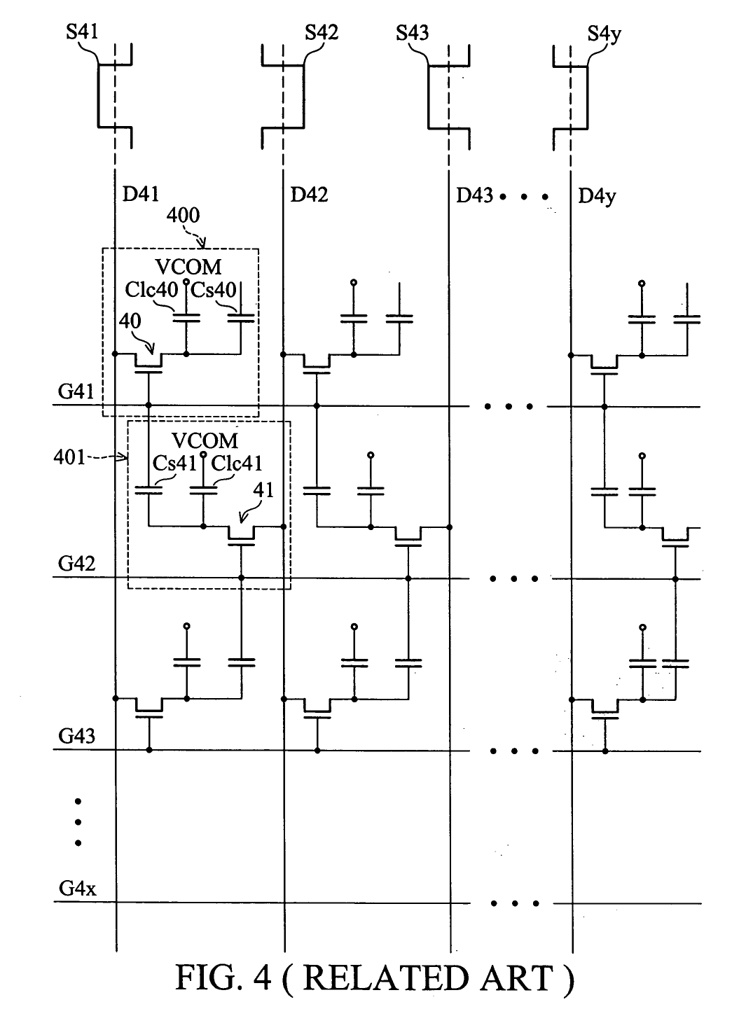

FIGS. 5a and 5b are schematic diagrams showing the LCD panel tested by check subpixel.

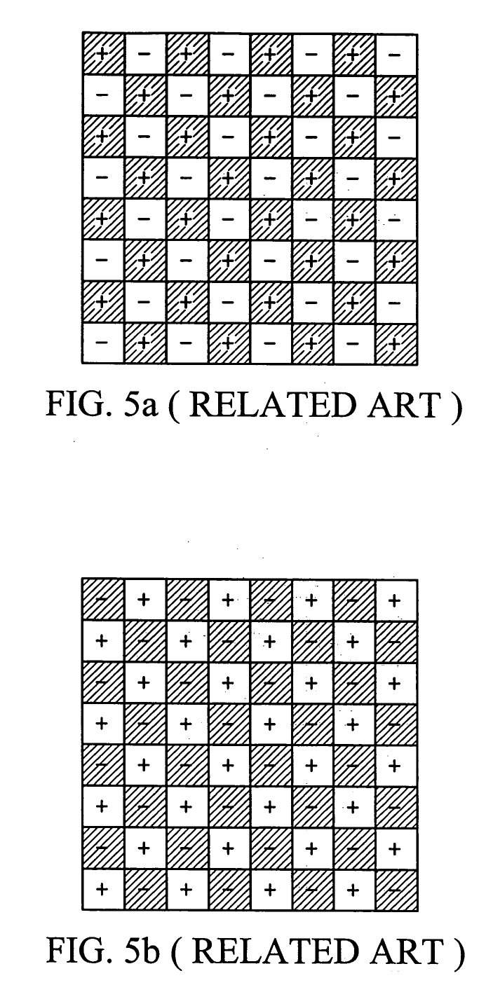

FIG. 6 shows a schematic diagram of the LCD panel of the present invention.

FIGS. 7a and 7b show polarities of the video signals received by each display unit pixel of the present invention.

FIGS. 8A and 8B are schematic diagrams showing the LCD panel tested by check subpixel according to the present invention.

### DETAILED DESCRIPTION OF THE INVENTION

The LCD panel of the present invention comprises a plurality of data lines and a plurality of scan lines. Each set of two adjacent data lines and two adjacent scan lines defines the boundary of one display unit pixel wherein each data line interlaces with both scan lines. Each of the display unit blocks disposed in array comprises a plurality of sequential display unit pixels parallel to a data line. The display unit pixels within any display unit block between two adjacent data lines are coupled to one of the two adjacent data lines, while the display unit pixels within another adjacent display unit block between the two adjacent data lines are coupled to the other of the two adjacent data lines. Display unit pixels within the two adjacent display unit blocks corresponding to one row are respectively coupled to two adjacent data lines. Four display unit blacks are used in the embodiment of the present invention, with each display unit black comprising two display unit pixels.

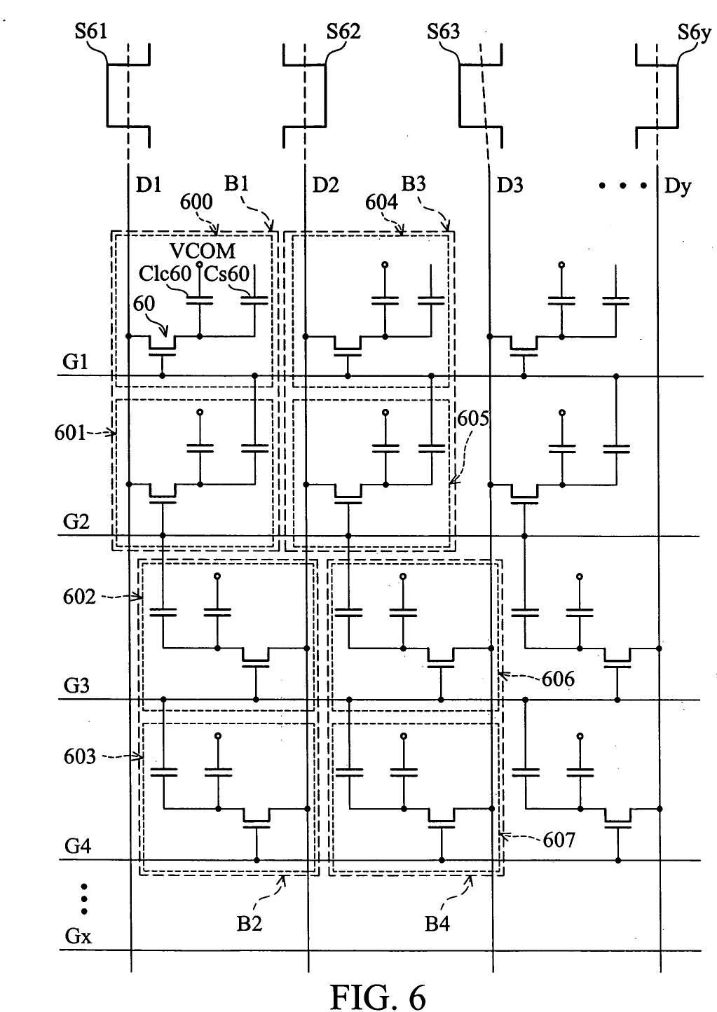

FIG. 6 shows a schematic diagram of the LCD panel of the present invention. Each of the video signals S61, S62, . . . , and S6y is carried respectively by data lines D1, D2, . . . , and Dy has a fixed polar level within a frame and another polar level with an opposite polarity within the next frame. As shown in FIG. 6, a first display unit block B1 has display unit pixels 600 and 601, a second display unit block B2 has display unit pixels 602 and 603, a third display unit block B3 has display unit pixels 604 and 605, and a fourth display unit block B4 has display unit pixels 606 and 607.

Like any other display unit pixel, the display unit pixel 600 comprises a control transistor 60, a storage capacitor Cs60, a pixel electrode, and a common electrode. The control transistor 60 comprises a source terminal, a gate terminal coupled to a first scan line G1, and a drain terminal coupled to the first data line D1. The storage capacitor Cs60 stores a driving voltage. The pixel electrode and the common electrode make up a liquid capacitor C1c60. Gate and drain terminals of a control transistor 61 within a display unit pixel 601 are respectively coupled to a second scan line G2 and the first data line D1. Gate and drain terminals of a control transistor 62 within a display unit pixel 602 are respectively coupled to a third scan line G3 and the second data line D2. Gate and drain terminals of a control transistor 63 within a display unit pixel 603 are respectively coupled to a fourth scan line G4 and the second data line D2. Gate and drain terminals of a control transistor 64 within a display unit pixel 604 are respectively coupled to the first scan line G1 and the second data line D2. Gate and drain terminals of a control transistor 65 within a display unit pixel 605 are respectively coupled to the second scan line G2 and the second data line D2. Gate and drain terminals of a control transistor 66 within a display unit pixel 606 are respectively coupled to the third scan line G3 and the third data line D3. Gate and drain terminals of a control transistor 67 within a display unit pixel 607 are respectively coupled to the fourth scan line G4 and the third data line D3. When all control transistors are turned on, the display unit pixels 600 and 601 receive the video signals carried by the first data line D1, the display unit pixels 602, 603, 604 and 605 receive the video signals carried by the second data line D2, and the display unit pixels 606 and 607 receive the video signals carried by the third data line D3.

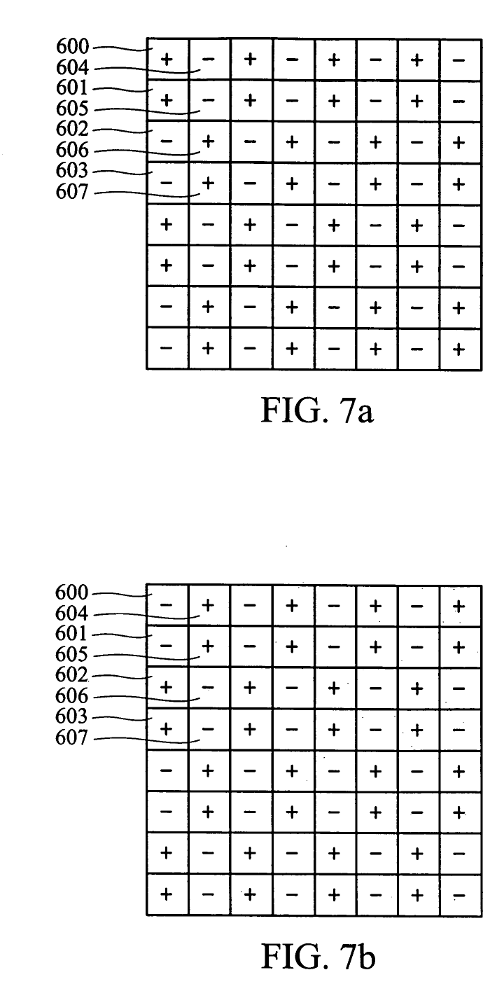

FIGS. 7a and 7b show polarities of the video signals received by each display unit pixel of the present invention. Moreover, FIG. 7b shows polarities of video signals within the frame next to that of FIG. 7a. Hereinafter it is assumed that polarities of the video signals S61 and S62 are respectively positive and negative. When a scan line corresponding to a row outputs a scan signal to turn on all control transistors within all display unit pixels corresponding to the row, data lines D1, D2, . . . , and Dy respectively output video signals S61, S62, . . . , and S6y to y display unit pixels corresponding to the row. As shown in FIG. 7a, video signals received by the display unit pixels 600, 601, 606, and 607 are positive, and video signals received by the display unit pixels 602, 603, 604, and 605 are negative. That is to say, the video signals received by the first display unit block B1 and the third display unit block B3 are both positive, and the video signals received by the second display unit block B2 and the fourth display unit block B4 are both negative. Contrarily, in FIG. 7 video signals received by the display unit pixels 600, 601, 606, and 607 are negative, and video signals received by the display unit pixels 602, 603, 604, and 605 are positive. That is to say, the video signals received by the first display unit block B1 and the third display unit block B3 are both negative, and the video signals received by the second display unit block B2 and the fourth display unit block B4 are both positive. Note that the polarity of the video signal S6y is not necessarily the same as that of the signal shown in FIG. 6, rather it is determined by a value y.

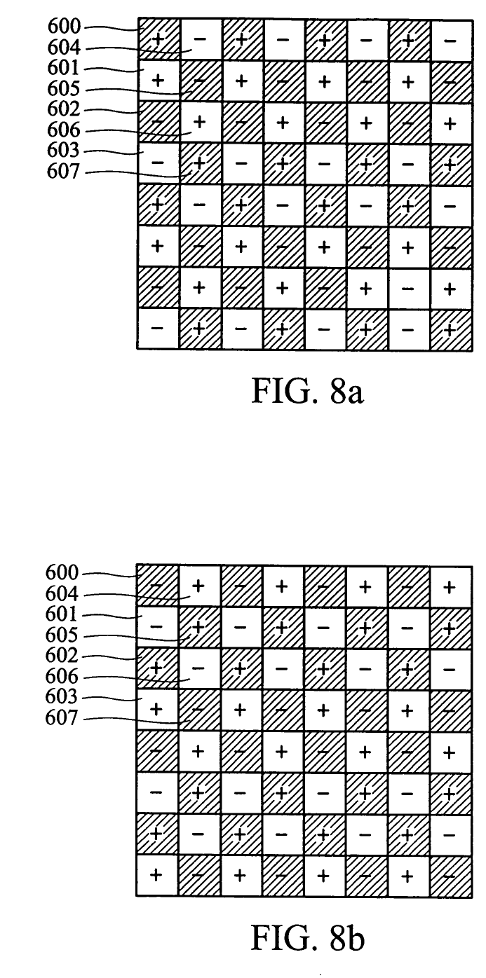

FIGS. 8A and 8B are schematic diagrams showing the LCD panel tested by check subpixel according to the present invention wherein white blocks and oblique blocks respectively represent display unit pixels turned on and off. FIG. 8b shows the schematic diagram of an LCD panel examined with check subpixel within the frame next to that of FIG. 8a. As shown in FIG. 8a, the polarity of any video signal received by display unit pixels turned on within a single frame is either positive or negative, and the positive video signal compensates the negative video signal for brightness, and vice versa. Similarly, within the next frame, as shown in FIG. 8b, the polarity of any video signal received by display unit pixels turned on is either positive or negative, and the positive video signal compensates the negative video signal for brightness, and vice versa. Therefore, flicker is not conspicuous when sequentially testing each single frame of the present invention with check subpixel.

In the present invention, each video signal has a fixed polar level within a frame and another polar level with an opposite polarity within the next frame. Therefore, comparing the conventional LCD panel and the present, lower frequency is used when alternately switching polarities of video signals between positive and negative, such that power is conserved. Additionally, flicker is less conspicuous when sequentially testing each single frame of the present invention with check subpixel, because the positive video signal compensates the negative video signal for brightness within each single frame, and vice versa.

When the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display panel, driven by a column inversion driving mode, comprising:
a plurality of parallel data lines, disposed along an X-axis;
a plurality of parallel scan lines, disposed along a Y-axis;
a plurality of display unit pixels, each having a control transistor, a storage capacitor, a common electrode, and a pixel electrode, wherein each set of two adjacent data lines and two adjacent scan lines defines the boundary of one display unit pixel wherein each data line interlaces with both scan lines; and
a plurality of display unit blocks disposed in array, each having display unit pixels parallel to and disposed sequentially along two adjacent data lines, wherein the display unit pixels within any display unit block between two adjacent data lines are coupled to one of the two adjacent data lines, while the display unit pixels within another adjacent display unit block between the two adjacent data lines are coupled to the other of the two adjacent data lines.

2. The liquid crystal display panel as claimed in claim 1, wherein the display unit pixels within any display unit block in a row and the display unit pixels within another adjacent display unit block in the row are coupled to different data lines.

3. The liquid crystal display panel as claimed in claim 1, wherein the common electrode and the pixel electrode make up a liquid capacitor.

4. A liquid crystal display panel, driven by a column inversion driving mode, comprising:
a plurality of data lines having a first data line and a second data line;
a plurality of scan lines having a first scan line and a second scan line;
a plurality of display unit pixels, each having a control transistor, a storage capacitor, a common electrode, and a pixel electrode, wherein each set of two adjacent parallel data lines and two adjacent parallel scan lines defines the boundary of one display unit pixel wherein each data line interlaces with both scan lines;
a first display unit block disposed between the first and the second data lines and having the display unit pixels parallel to and disposed sequentially along the first and the second data lines, wherein the display unit pixels are coupled to the first data line; and
a second display unit block disposed between the first and the second data lines, adjacent to the first display unit block, and having the display unit pixels parallel to and disposed sequentially along the first and the second data lines, wherein the display unit pixels are coupled to the second data line.

5. The liquid crystal display panel as claimed in claim 4, further comprising:
a third data line;
a third scan line;
a third display unit block disposed between the second and the third data lines and having the display unit pixels parallel to and disposed sequentially along the second and the third data lines, wherein the display unit pixels are coupled to the second data line; and
a fourth display unit block disposed between the second and the third data lines, adjacent to the third display unit block, and having the display unit pixels parallel to and disposed sequentially along the second and the third data lines, wherein the display unit pixels are coupled to the third data line.

6. The liquid crystal display panel as claimed in claim 4, wherein the common electrode and the pixel electrode make up a liquid capacitor.

7. The liquid crystal display panel as claimed in claim 4, wherein the polarity of the first display unit block is opposite that of the second display unit block upon completion of the column inversion driving mode.

8. The liquid crystal display panel as claimed in claim 5, wherein the common electrode and the pixel electrode make up a liquid capacitor.

9. The liquid crystal display panel as claimed in claim 5, wherein upon completion of the column inversion driving mode, the polarity of the first display unit block is the same as that of the fourth display unit block, and polarities of both the second and the third display unit blocks are opposite those of the first display unit block.
